(19) United States
(12) Patent Application Publication
(10) Pub. No.: US 2014/0023948 A1
(43) Pub. Date: Jan. 23, 2014

(54) ENHANCEMENT OF IN SITU RADIATION FOR FACILITATED THERMAL MANAGEMENT OF HIGH TEMPERATURE FUEL CELLS

(71) Applicant: Georgia Tech Research Corporation, Atlanta, GA (US)

(72) Inventors: Comas Haynes, Covington, GA (US); Diane England, Avondale Estates, GA (US); Brian Schwartz, Atlanta, GA (US)

(21) Appl. No.: 13/944,285

(22) Filed: Jul. 17, 2013

Related U.S. Application Data
(60) Provisional application No. 61/672,452, filed on Jul. 17, 2012.

(51) Int. Cl. H01M 8/04

(52) U.S. Cl. CPC H01M 8/04014
USPC 429/434

(57) ABSTRACT

The various embodiments described herein provide an alternative solid oxide fuel cell (SOFC) design that enhances radiation heat transfer. The premise is to facilitate view factor radiation as an additional means of thermal equilibration along and between the high temperature fuel cells, such that the cells become more tolerant to colder inlet oxidant streams or direct internal reformation, as well as have enhanced proximity of temperatures between one another. Previously threatening “cold spots” due to convective cooling and endothermic reformation effects could be minimized or avoided via thermal radiation that ultimately originates from hotter cell locations. Likewise, previously threatening “temperature glides” throughout the direction of cell stacking are mitigated by the cells having more (reflective) thermal radiation between themselves.

### CROSS-REFERENCE TO RELATED APPLICATIONS

This application claims priority to U.S. Provisional Application No. 61/672,452, filed Jul. 17, 2012. This application is hereby incorporated by reference in its entirety as if fully set forth below.

### FIELD OF THE INVENTION

The present invention relates generally to solid oxide fuel cell technology and methods of manufacturing and using the same.

### BACKGROUND OF THE INVENTION

Solid oxide fuel cells (SOFCs) are used to generate electricity from fuel gas and air and typically have three active components: (1) an anode, or fuel electrode; (2) a cathode, or oxygen electrode; and (3) the electrolyte, which is located between the anode and the cathode. The electrolyte, which is prevalently a solid oxide material, is the primary means of categorizing these cells. Additionally, an electrically conducting interconnect provides for electrical contact between the cells at both the anodes and the cathodes of sequenced cells. In the normal operation of an SOFC, an oxidant, for example, air, is supplied to the cathode. The oxygen from the air dissociatively adsorbs at the cathode surface, migrates to the ionically conductive electrolyte, ionizes, and the resulting oxygen ions transport through the electrolyte. This transport across the ionically conducting electrolyte is driven by an oxygen ion concentration gradient as well as an electric field. At the anode, a fuel such as hydrogen gas reacts with the oxygen ions to form water and liberate electrons. The electrons are released and transported through the electrically conducting anode, through the interconnect and on to the cathode of the neighboring cell to repeat the process. Electrons released at the anode flow through a series of cells and ultimately through a load and back to the first cathode where they once again begin their cycle. These phenomena cause energy conversion, much of which manifests itself as an increase in the electrical potential of the system.

SOFC systems possess the capability for highly-efficient power production at a low level of emissions. However, these fragile, high-temperature cells are prone to thermal failure, which shortens their life-span and hinders their marketability. Thermal radiation has proven itself effective at mitigating temperature gradients, and preventing thermal failure, in tubular SOFC stacks. However, conventional planar SOFC design does not allow for sufficient radiation exchange inside gas flow channels to have a significant impact on temperature gradients.

Therefore, in order to prevent excessive temperature gradients and thermal shock in conventional SOFC designs, air must be preheated (e.g., to approximately 650° C.) before it is sent to a SOFC stack. This requirement adds to system complexity and cost, because a preheater must be included and further because excess air must be pumped to the cell in order to remove the heat generated by the cell reactions. Thermal failure and additional system costs can be avoided if temperature gradients are minimized by enhancing radiation heat transfer inside the SOFC stack. It is to this need that the present invention is directed.

### SUMMARY OF THE INVENTION

An example embodiment of the present invention provides a solid oxide fuel cell, comprising at least one flow channel extending a length of the fuel cell, the channel having a length to hydraulic diameter ratio not exceeding 20. In some embodiments, the flow channel may have a length to hydraulic diameter ratio ranging from 3 to 10.

Another example embodiment of the present invention provides a solid oxide fuel cell, comprising at least one flow channel extending a length of the fuel cell, the flow channel having a length to hydraulic diameter ratio not exceeding 20, and a reflective surface coating applied to at least a portion of an interior of at least one reactant manifold. The flow channel may have a length to hydraulic diameter ratio ranging from 3 to 10. The reflective surface coating may be a polished metal. The polished metal may be selected from the group consisting of chrome, nickel, zinc, and silver. In some embodiments, the reflective surface coating may be pyrogel. In some embodiments, the reflective surface coating may itself be coated by aerogel. Further, in some embodiments, the flow channel may be contoured and/or flanged.

Another example embodiment of the present invention provides a fuel cell system, comprising a fuel cell stack comprising at least one solid oxide fuel cell, the solid oxide fuel cell comprising at least one flow channel extending a length of the fuel cell stack, the flow channel having a length to hydraulic diameter ratio not exceeding 20, and a reflective surface coating applied to at least a portion of an interior of at least one reactant manifold. The flow channel may have a length to hydraulic diameter ratio ranging from 3 to 10, and the reflective surface coating may itself be coated by aerogel.

Another example embodiment of the present invention provides a solid oxide fuel cell stack, comprising a plurality of fuel cell units, each fuel cell unit comprising at least one flow channel having an anode electrode, a cathode electrode, and an electrolyte disposed therebetween, and an electrically conducting interconnect, wherein contacts between interconnect and the electrodes are contoured, and wherein at least one flow channel has a length to hydraulic diameter ratio of less than 20 and a reflective surface coating applied to at least a portion of an interior of at least one reactant manifold. Further, at least one flow channel may have a length to hydraulic diameter ratio ranging from 3 to 10. The reflective surface coating may be a polished metal. The polished metal may be selected from a group consisting of chrome, nickel, zinc, and silver. The reflective surface coating may be pyrogel. The reflective surface coating may itself be coated by aerogel.

### BRIEF DESCRIPTION OF THE DRAWINGS

FIG. 1 illustrates a prior art conventional planar solid oxide fuel cell (SOFC) design.

FIG. 2 illustrates an example embodiment of an SOFC design having broader gas flow channels that are adapted to enhance radiation heat transfer in accordance with the present invention.

FIG. 3 illustrates an interior view of a conventional planar SOFC.

FIG. 4 illustrates an interior view of an example embodiment of the SOFC design in accordance with the present invention.

FIG. 5(a) illustrates the relatively small effect of radiation within prior art conventional SOFC designs.

FIG. 5(b) illustrates the effect of radiation within SOFC designs of the present invention.

### DETAILED DESCRIPTION OF THE INVENTION

Referring now to the figures, wherein like reference numerals represent like parts throughout the several views, exemplary embodiments of the present invention will be described in detail. Throughout this description, various components can be identified as having specific values or parameters, however, these items are provided as exemplary embodiments. Indeed, the exemplary embodiments do not limit the various aspects and concepts of the present invention as many comparable parameters, sizes, ranges, and/or values can be implemented

It should also be noted that, as used in the specification and the appended claims, the singular forms “a,” “an,” and “the” include plural references unless the context clearly dictates otherwise. For example, reference to a component is intended also to include composition of a plurality of components. References to a composition containing “a” constituent is intended to include other constituents in addition to the one named. Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Values may be expressed herein as “about” or “approximately” one particular value, this is meant to encompass the one particular value and other values that are relatively close but not equal to the one particular value. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The various embodiments described herein provide a solid oxide fuel cell (SOFC) design that enhances radiation heat transfer. The premise is to facilitate view factor radiation as an additional means of thermal equilibration along and between the high temperature fuel cells, such that the cells in the stack become more tolerant to colder inlet oxidant streams or direct internal reformation, as well as closer in temperature to each other. Previously threatening “cold spots” due to convective cooling and endothermic reformation effects could be minimized or avoided via thermal radiation that ultimately originates from hotter cell locations Likewise, previously threatening “temperature glides” throughout the direction of cell stacking are mitigated by the cells having more (reflective) thermal radiation between themselves.

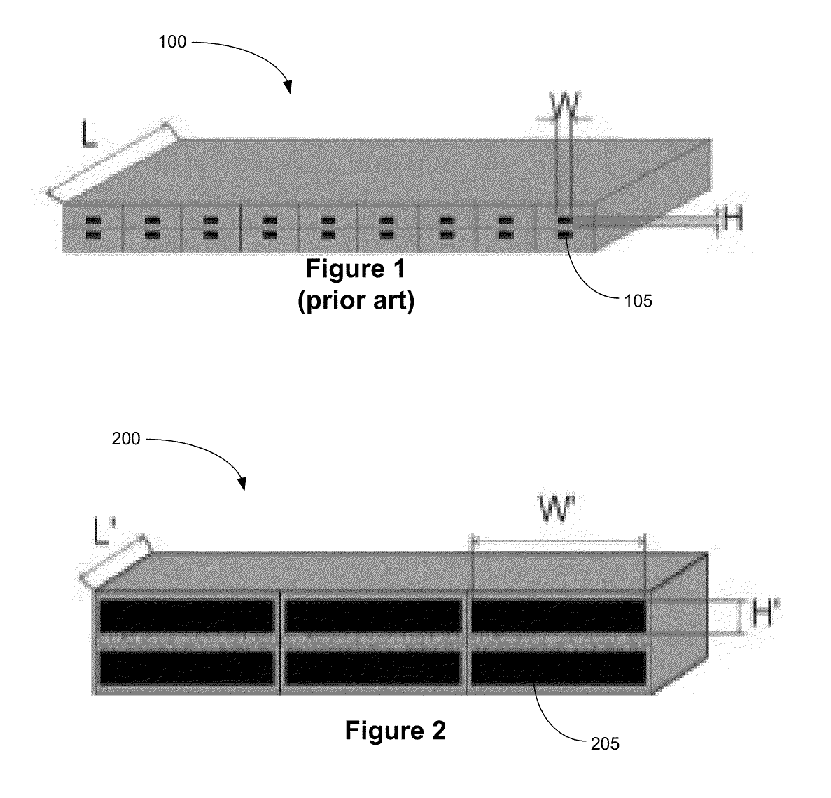

Conventional planar SOFCs, as conceptually illustrated in FIG. 1, possess many long, narrow gas flow channels for the supply of oxygen and fuel to the cell. Although this design possesses many advantages, it inhibits the exchange of enclosure radiation along the length of the cell. This geometric design, coupled with relatively modest operating temperatures (˜950-1100K), explains why radiation is often neglected in planar SOFC models. However, if gas flow channels were redesigned to optimize radiation exchange, the effect of radiation on temperature gradients could be significant. The present invention accomplishes this by: (1) decreasing the length to hydraulic diameter ratio of gas flow channels, (2) transitioning the contacts between interconnect and electrodes from being constant cross-sectional ribs to optimally contoured flange-type arrangements, and (3) applying an interior surface coating along manifold “caps” or reactants supply/exhaust headers to approach complete reflectivity and re-radiation, therefore increasing pathways for radiation between two surfaces via both direct “lines of sight” and paths of reflection.

As illustrated in FIG. 1, conventional planar SOFC models (100) had long and narrow gas flow channels (105). In conventional or traditional planar SOFC models (100), it is typical to have numerous (e.g., 25) gas flow channels (105), wherein the width (w) of the gas channel is around 2 millimeters (mm), the height (h) of the gas channel is around 2 mm, and the length is around 100 mm. It shall be understood that these are merely example embodiments, and should no way be read to encompass all conventional planar SOFC models (100). Because of the long and narrow geometries of conventional planar SOFC models (100), it does not allow for sufficient radiation exchange inside the gas flow channels to have a significant impact upon temperature gradients. Thus, conventional designs are highly sensitive to thermal failure, such as warping and cracking, which subsequently lessens the performance and operating life of SOFCs.

The first redesign measure to facilitate radiation as a heightened means of thermal equilibration is to significantly reduce the number of gas flow channels (e.g., to a few pairs of oxidant and fuel passageways). FIG. 2 illustrates an example embodiment of an SOFC design (200) in accordance with the present invention. Example embodiments of the present invention significantly reduce the length to hydraulic diameter ratio of each gas flow channel (205), hence augmenting the view factors between axial locations along the passageway. This geometric ratio may also be reduced by increasing the height of the channel (205), but there is the added consideration of a more voluminous cell and stack occurring.

One skilled in the art will appreciate that hydraulic diameter (dₕ) is commonly used when dealing with non-circular channels, as in the instant embodiments, and is generally defined as:

$${d}_{h} = 4 ( \frac{cross - sectional area of channel}{wetted perimeter of channel} )$$

In example embodiments of the present invention, the length to hydraulic diameter ratio of each flow channel does not exceed 20. In other embodiments, the length to hydraulic diameter ratio of each flow channel ranges between 3 and 10. Again, it is the enforced temperature uniformity that fosters a greater amenability to internal reformation and/or smaller supplies of colder air, therefore making the SOFC more thermally tolerant. This length to hydraulic diameter ratio also allows for enhanced temperature uniformity between the cells, as promoted by radiation.

As illustrated in FIG. 2, there is shown an SOFC (200) having six individual gas flow channels 205. It shall be understood that this is an example embodiment of the present invention, and does not exclude alternative embodiments having a different number of gas flow channels.

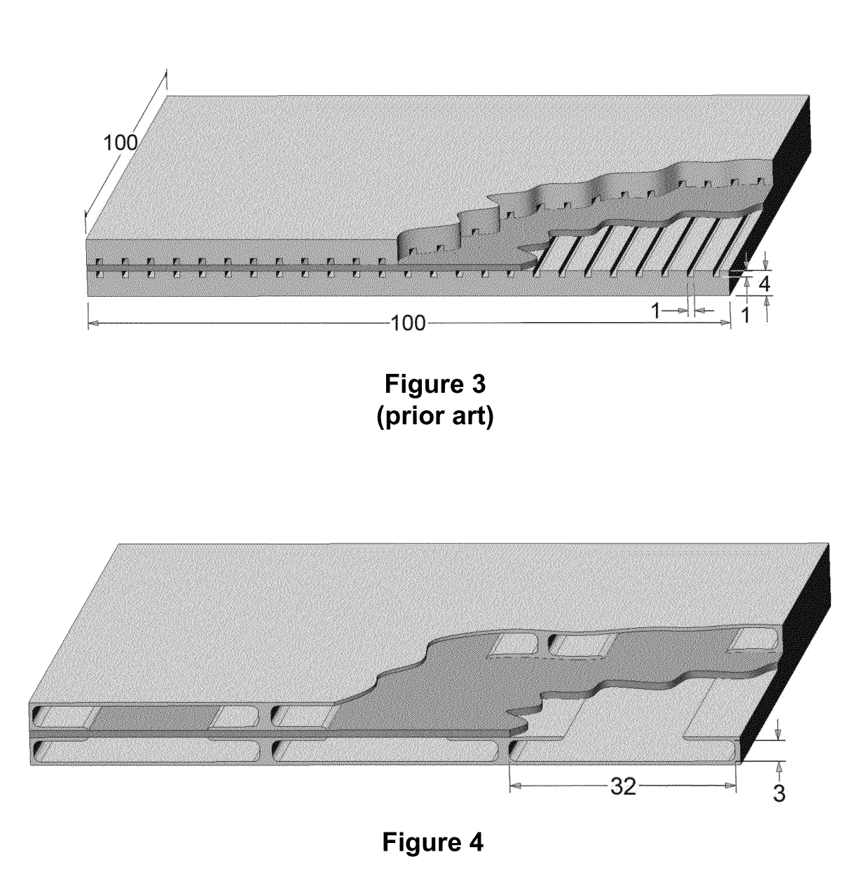

Second, in example embodiments of the present invention, contacts between interconnect and electrodes are transitioned from being constant cross-sectional ribs, as illustrated in FIG. 3 (prior art), to optimally contoured (or flanged) arrangements, as illustrated in FIG. 4. More specifically, in example embodiments, the gas flow channels may be contoured by making the height and or width of the cross-sectional ribs variable. Furthermore, in example embodiments, a flange may be added to the ribs to allow for improved contact area. Accordingly, the bulk of the channel cross-section in example embodiments is a widened passageway (hence heightened axial view factors), however physical contact between interconnect and electrode is not as diminished (hence sheet and contact resistances are constrained).

Finally, in example embodiments of the present invention, the interior surfaces of the manifold reactants supply and exit “caps” or ports may be coated with a reflective surface coating to approach complete reflectivity and re-radiation, therefore increasing pathways for radiation between two surfaces via both direct “lines of sight” and paths of reflection. Example reflective surface coatings include, but are not limited to, polished metals such as chrome, nickel, zinc and silver, as well as other materials such as pyrogel, or combinations thereof. Additionally, a conductively-convectively insulative, yet radiatively transmissive, coating such as aerogel may be disposed between the reflective surface coatings and the SOFC stack for a conductive-convective insulative effect. Given this insulative effect, surface oxidation of the reflective material may not be as likely, and the reflection effects are hence preserved. It shall also be understood that the reflective material consequently minimizes heat gain on SOFC stack housings, therefore reducing the need for external insulation.

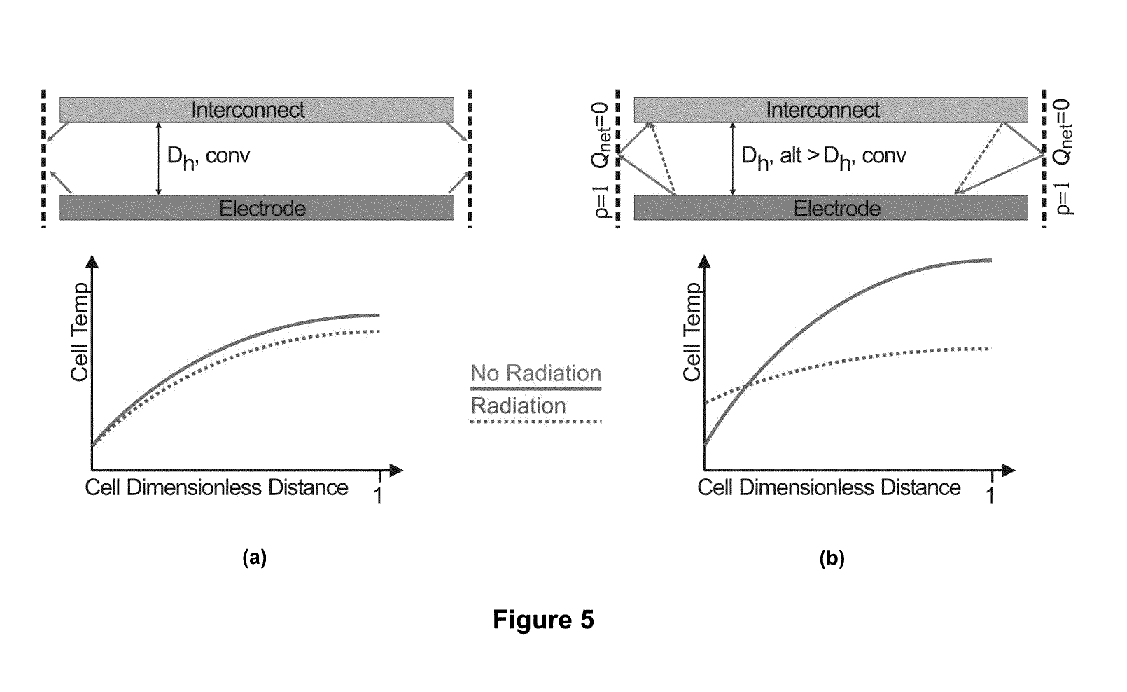

As illustrated in FIG. 5b, there is shown increased pathways for radiation between two surfaces via both direct “lines of sight” and paths of reflection. The comprehensive effect is that radiation is permitted to have a more pronounced effect upon thermal equilibration along the cell. FIG. 5a shows the relatively small effect of radiation within conventional scenarios of slender channel passageways exposed to generalized housing (e.g., reactants manifolds) interior surfaces; while FIG. 5b shows an improved approach to temperature uniformity that radiation promotes in the alternative design. Again, it is the enforced temperature uniformity that fosters a greater amenability to internal reformation and/or smaller supplies of colder air. Additionally, there is enhanced capability to quickly equilibrate temperature given transient phenomena, since radiation is not limited by thermal capacitive effects associated with transient conduction or convection. The entire stack's thermal equilibration is also assisted, since the individual cells have enhanced thermal communication with each other via the reflective coatings.

Such thermal engineering has historically received little attention in SOFC subsystem design due to either the complexity of including radiation analysis and/or its smaller impact upon traditional designs. Preliminary analyses, however, have revealed a tractable approach to modify the non-electroactive components of the stack (i.e., interconnects and reactant supply manifolding) to significantly improve cell temperature profiles experienced at favorable design settings inclusive of lowered oxidant supply and inlet temperature.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

1. A solid oxide fuel cell, comprising:
at least one flow channel extending a length of the fuel cell, the channel having a length to hydraulic diameter ratio not exceeding 20.

2. The solid oxide fuel cell of claim 1, wherein the at least one flow channel has a length to hydraulic diameter ratio ranging from 3 to 10.

3. A solid oxide fuel cell, comprising:
at least one flow channel extending a length of the fuel cell, the at least one flow channel having a length to hydraulic diameter ratio not exceeding 20; and
a reflective surface coating applied to at least a portion of an interior of the at least one flow channel.

4. The solid oxide fuel cell of claim 3, wherein the at least one flow channel has a length to hydraulic diameter ratio ranging from 3 to 10.

5. The solid oxide fuel cell of claim 3, wherein the reflective surface coating is a polished metal.

6. The solid oxide fuel cell of claim 5, wherein the polished metal is selected from the group consisting of chrome, nickel, zinc, and silver.

7. The solid oxide fuel cell of claim 3, wherein the reflective surface coating is pyrogel.

8. The solid oxide fuel cell of claim 3, wherein the reflective surface coating is itself coated with a conductively-convectively insulative material.

9. The solid oxide fuel cell of claim 8, wherein the conductively-convectively insulative material is aerogel.

10. The solid oxide fuel cell of claim 3, wherein the at least one flow channel is contoured.

11. The solid oxide fuel cell of claim 3, wherein the at least one flow channel is flanged.

12. A fuel cell system, comprising:
a fuel cell stack comprising at least one solid oxide fuel cell, the solid oxide fuel cell comprising:
at least one flow channel extending a length of the fuel cell stack, the flow channel having a length to hydraulic diameter ratio not exceeding 20; and
a reflective surface coating applied to at least a portion of an interior of the at least one flow channel.

13. The fuel cell system of claim 12, wherein at least one flow channel has a length to hydraulic diameter ratio ranging from 3 to 10.

14. A solid oxide fuel cell stack, comprising:
a plurality of fuel cell units, each fuel cell unit comprising
at least one pair of reactant stream flow channels having an anode electrode, a cathode electrode, and an electrolyte disposed therebetween, and
an electrically conducting interconnect, wherein contacts between interconnect and the electrodes are contoured, and
wherein the at least one flow channel has a length to hydraulic diameter ratio of less than 20, and an interior reflective surface coating.

15. The solid oxide fuel cell stack of claim 14, wherein the at least one flow channel has a length to hydraulic diameter ratio ranging from 3 to 10.

16. The solid oxide fuel cell stack of claim 14, wherein the reflective surface coating is a polished metal.

17. The solid oxide fuel cell stack of claim 16, wherein the polished metal is selected from the group consisting of chrome, nickel, zinc, and silver.

18. The solid oxide fuel cell of claim 14, wherein the reflective surface coating is pyrogel.

19. The solid oxide fuel cell of claim 14, wherein the reflective surface coating is itself coated with a conductively-convectively insulative material.

20. The solid oxide fuel cell of claim 19, wherein the conductively-convectively insulative material is aerogel.
